(19) United States
(12) Patent Application Publication
(10) Pub. No.: US 2026/0127490 A1
(43) Pub. Date: May 7, 2026

(54) METHOD FOR CREATING MACHINE LEARNING MODEL FOR ESTIMATING STATE OF FLUID IN TANK, AND METHOD FOR ESTIMATING STATE OF FLUID IN TANK USING MACHINE LEARNING MODEL

(71) Applicant: CHIYODA CORPORATION, Yokohama-shi, Kanagawa (JP)

(72) Inventors: Takehito YASUI, Kanagawa (JP); Yuzuru ITO, Kanagawa (JP); Junko KITAMOTO, Kanagawa (JP); Satoshi SUGIYAMA, Kanagawa (JP)

(21) Appl. No.: 19/118,095

(22) PCT Filed: Oct. 18, 2023
(86) PCT No.: PCT/JP2023/037667

§ 371 Date: Apr. 3, 2025

(30) Foreign Application Priority Data
Oct. 26, 2022 (JP) 2022-171285

(51) Int. Cl. G06N 20/00

(52) U.S. Cl. CPC G06N 20/00

(57) ABSTRACT

[Problem] To provide a method for creating a machine learning model that allows for a quick and accurate estimation of a state of a fluid in a tank.

[Solution] The method for creating a machine learning model for estimating a state of a fluid in a tank, wherein the fluid contains a plurality of substances, the method comprising: creating a plurality of parameter sets, each set comprising tank information including at least a shape and size of the tank, operating conditions of the tank, and substance information including at least an amount, and one or more physical properties of each of the plurality of substances, wherein the plurality of parameter sets are created by varying the parameters of the operating conditions and the substance information; performing a numerical fluid dynamics analysis based on the plurality of parameter sets to provide a plurality of calculation results based on fluid information including distributions of physical quantities related to the fluid and/or an amount of each of the plurality of substances; and creating the machine learning model by a machine learning operation which involves training the machine learning model with teaching data including the plurality of parameter sets and the corresponding plurality of calculation results.

### TECHNICAL FIELD

The present invention relates to a method for creating a machine learning model for estimating a state of a fluid in a tank and a method for estimating a state of a fluid in a tank using a machine learning model.

### BACKGROUND ART

Patent Document 1 discloses a cell culture apparatus comprising a culture tank, a stirring blade in the culture tank, a drive unit that allows the stirring blade to rotate, and a control unit that controls the drive unit. The cell culture apparatus performs fluid analysis by using variables that include a density of a substance contained in a culture fluid, a viscosity of the culture fluid, a shape of the culture tank, the shape of the stirring blade, a condition of a wall surface of the culture tank, and the number of rotations of the stirring blade, to thereby calculate a shear stress distribution within the culture tank, and then controls the drive device such that the shear stress distribution is within a predetermined range.

### PRIOR ART DOCUMENT(S)

### Patent Document(s)

Patent Document 1: JP 2014-124139A

### SUMMARY OF THE INVENTION

### Task to be Accomplished by the Invention

However, the prior art technology involves a problem that the fluid analysis requires a lot of time for numerical calculations, making it difficult to use calculation results in controlling the cell culture apparatus on a real-time basis, and in improving the culture conditions. Moreover, cells in a culture medium proliferate exponentially, causing the viscosity of the culture medium to increase rapidly in a short period of time. As a result, the long period of time used for fluid analysis tends to cause a problem that calculation results do not match a current state of the culture fluid.

The present invention has been made in view of the problems of the prior art, and a primary object of the present invention is to provide a method for creating an estimation model (in particular, machine learning model) that allows for a quick and accurate estimation of a state of a fluid in a tank. Another object of the present invention is to provide a method for estimating a state of a fluid in a tank by using such an estimation model.

### Means to Accomplish the Task

As a solution to the above-described tasks to be accomplished, a first aspect of the present invention provides a method for creating a machine learning model for estimating a state of a fluid in a tank, wherein the fluid contains a plurality of substances, the method comprising: creating a plurality of parameter sets, each set comprising tank information including at least a shape and size of the tank, operating conditions of the tank, and substance information including at least an amount, and one or more physical properties of each of the plurality of substances, wherein the plurality of parameter sets are created by varying the parameters of the operating conditions and the substance information; performing a numerical fluid dynamics analysis based on the plurality of parameter sets to provide a plurality of calculation results as fluid information, wherein the fluid information includes distributions of physical quantities related to the fluid and/or an amount of each of the plurality of substances; and creating the machine learning model by a machine learning operation which involves training the machine learning model with teaching data including the plurality of parameter sets and the corresponding plurality of calculation results.

In this configuration, a machine learning model is created using calculation results of a numerical fluid dynamics analysis, which allows for an accurate estimation of a state of a fluid in a tank through the use of the machine learning model. Calculations with the use of the machine learning model require a shorter time than those with the numerical fluid dynamics analysis, which allows for a quick estimation of the state of the fluid in the tank. In addition, the tank information used in the numerical fluid dynamics analysis is the same as that for the actual tank, which allows for reduction of input data required for calculations with the use of the machine learning model.

A second aspect of the present invention provides a method for creating a machine learning model for estimating a state of a fluid in a tank, wherein the fluid contains a plurality of substances, the method comprising: creating a plurality of parameter sets, each set comprising tank information including at least a shape and size of the tank, operating conditions of the tank, and substance information including at least an amount, and one or more physical properties of each of the plurality of substances, wherein the plurality of parameter sets are created by varying the parameters of the tank information, the operating conditions, and the substance information; performing a numerical fluid dynamics analysis based on the plurality of parameter sets to provide a plurality of calculation results as fluid information, wherein the fluid information includes distributions of a physical quantities related to the fluid and/or an amount of each of the plurality of substances; and creating the machine learning model by a machine learning operation which involves training the machine learning model with teaching data including the plurality of parameter sets and the corresponding plurality of calculation results.

This configuration allows for the creation of machine learning models for tanks of various sizes and shapes.

The method may be further configured such that the plurality of substances comprise cells or microorganisms, and wherein the fluid information includes the distributions and/or the total number of the cells or microorganisms.

This configuration allows for estimation of at least one of the distribution and the total number of the cells or microorganisms in the tank through the use of the machine learning model.

The method may be further configured such that the step of creating the machine learning model comprising: extracting first fluid information related to the state of the fluid at a first position in the tank from the plurality of calculation results, and creating the teaching data by using: the tank information, the operating conditions of the tank, the one or more physical properties of each of the plurality of substances, and the extracted first fluid information as explanatory variables; and the fluid information including the distributions of the physical quantities related to the fluid and/or the amount of each of the plurality of substances at each position in the tank as objective variables.

A third aspect of the present invention provides a method for estimating the state of the fluid in the tank using the machine learning model created by the method of the first aspect, the method comprising: inputting first fluid information related to the state of the fluid at a first position in the tank, the operating conditions, and the substance information to the machine learning model, thereby providing the fluid information as output data of the machine learning model.

In this configuration, a machine learning model is created using calculation results of a numerical fluid dynamics analysis, which allows for an accurate estimation of a state of a fluid in a tank through the use of the machine learning model. Calculations with the use of the machine learning model require a shorter time than those with the numerical fluid dynamics analysis, which allows for a quick estimation of the state of the fluid in the tank. In addition, the tank information used in the numerical fluid dynamics analysis is the same as that for the actual tank, which allows for reduction of input data required for calculations with the use of the machine learning model. Furthermore, the calculations are made based on the first fluid information related to the state of the fluid at a first position in the tank, which allows for a more accurate estimation of the state of the fluid in the tank.

A fourth aspect of the present invention provides a method for estimating the state of the fluid in the tank using the machine learning model created by the method of the first aspect, the method comprising: inputting first fluid information related to the state of the fluid at a first position in the tank, second fluid information related to the state of the fluid at a second position in the tank, the operating conditions, and the substance information to the machine learning model, thereby providing the fluid information as output data of the machine learning model.

In this configuration, the calculations are made based on the first fluid information and the second information related to the states of the fluid at first and second positions in the tank, respectively, which allows for an even more accurate estimation of the state of the fluid in the tank.

A fifth aspect of the present invention provides a method for estimating the state of the fluid in the tank using the machine learning model created by the method of the second aspect, the method comprising: inputting first fluid information related to the state of the fluid at a first position in the tank, the tank information, the operating conditions, and the substance information to the machine learning model, thereby providing the fluid information as output data of the machine learning model.

This configuration allows for a quick and accurate estimation of a state of a fluid in the tank which is any of various types.

A sixth aspect of the present invention provides a method for estimating the state of the fluid in the tank using the machine learning model created by the method of the second aspect, the method comprising: inputting first fluid information related to the state of the fluid at a first position in the tank, second fluid information related to the state of the fluid at a second position in the tank, the tank information, the operating conditions, and the substance information to the machine learning model, thereby providing the fluid information as output data of the machine learning model.

This configuration allows for a quick and accurate estimation of a state of a fluid in the tank which is any of various types. In addition, the calculations are made based on the first fluid information and the second information related to the states of the fluid at first and second positions in the tank, respectively, which allows for an even more accurate estimation of the state of the fluid in the tank.

The method may be further configured such that the machine learning model outputs the calculation results for the first fluid information.

This configuration allows for an evaluation of the accuracy of the machine learning model by comparing the first fluid information acquired by a sensor or any other device, with the first fluid information output from the machine learning model.

The method may be further configured such that the plurality of substances comprise cells or microorganisms, and wherein the fluid information includes the distributions and/or the total number of the cells or microorganisms.

This configuration allows for estimation of at least one of the distribution and the total number of the cells or microorganisms in the tank.

The method may be further configured such that the first fluid information is a number of the cells or microorganisms at the first position.

This configuration can improve the estimation accuracy in the estimation of at least one of the distribution and the total number of the cells or microorganisms in the tank.

The method may be further configured such that the first fluid information is acquired based on an electrical conductivity of the fluid at the first position.

This configuration makes it possible to acquire the total number of the cells or microorganisms in the tank at a first position in the tank.

The method may be further configured such that the operating conditions include a stirring condition of the tank.

This configuration allows for an estimation of the state of fluid in the tank, taking into account the state of stirring in the tank.

The method may be further configured such that the numerical fluid dynamics analysis is a first numerical fluid dynamics analysis, the method comprising:
performing a second numerical fluid dynamics analysis based on the plurality of parameter sets and a further parameter set related to an additional substance to be put into the tank after the tank starts operation; calculating an additional substance diffusion time, which is a time required for the additional substance to diffuse to every position in the tank, based on results of the second numerical fluid dynamics analysis; and creating the machine learning model by a machine learning operation which involves training the machine learning model with teaching data including the plurality of parameter sets and the further parameter set related to the additional substance, and the additional substance diffusion time.

This configuration makes it possible to create a machine learning model used in an estimation of the state of fluid in the tank, taking into account the additional substance.

The method for estimating the state of the fluid and the additional substance diffusion time may be further configured such that the method comprises: inputting first fluid information related to the state of the fluid at a first position in the tank, the operating conditions, and the substance information to the machine learning model, thereby providing the fluid information as output data of the machine learning model; and inputting first fluid information related to the state of the fluid at a first position in the tank, the operating conditions, the substance information, and information related to the additional substance to the machine learning model, thereby providing the substance information and the additional substance diffusion time as output data of the machine learning model.

This configuration makes it possible to acquire an additional substance diffusion time required for the additional substance to diffuse in the tank.

The method may be further configured such that the substance information includes an amount, a physical quantity, a put-in position, and a put-in rate of an additional substance to be put into the tank at a predetermined put-in time.

This configuration allows for an estimation of the state of fluid in the tank, taking into account the additional substance.

The method may be further configured to further comprise inputting a plurality of sets of input data to the machine learning model, thereby providing a plurality of sets of the fluid information as output data of the machine learning model, wherein the plurality of sets of input data are created by varying the put-in time at which the additional substance is put into the tank; calculating additional substance diffusion times, each being a time required for the additional substance to diffuse in the tank, for the plurality of sets of the fluid information; and determining a put-in time which minimizes the additional substance diffusion time based on the additional substance diffusion times for the plurality of sets of the fluid information.

This configuration allows for the determination of the put-in time which minimizes the additional substance diffusion time.

### Effect of the Invention

The present invention embodied as described above, can provide a method for creating an estimation model (in particular, machine learning model) that allows for a quick and accurate estimation of a state of a fluid in a tank. The present invention can also be embodied to provide a method for estimating a state of a fluid in a tank by using such an estimation model.

### BRIEF DESCRIPTION OF THE DRAWINGS

FIG. 1 is an explanatory diagram showing a tank according to one embodiment of the present invention;

FIG. 2 is an explanatory diagram showing an operation screen displayed on a display;

FIG. 3 is an explanatory diagram showing an operation screen displayed on the display;

FIG. 4 is an explanatory diagram showing a control screen displayed on a display;

FIG. 5 is a flowchart showing an operation procedure for creating a machine learning model;

FIG. 6 is an explanatory diagram showing how parameter sets are related to calculation results of a numerical fluid dynamics analysis;

FIG. 7 is an explanatory diagram showing the relationship between time and fluid information;

FIG. 8 is a flowchart showing an operation procedure for creating a machine learning model used for estimating an additional substance diffusion time required for an additional substance to diffuse to every position in the tank;

FIG. 9 is an explanatory diagram showing examples of input data and output data of first numerical fluid dynamics analyses and those of second numerical fluid dynamics analyses;

FIG. 10 is a flowchart showing an operation procedure of an optimal put-in time calculation operation of the additional substance, (i.e., an operation for calculating an optimal put-in time for the additional substance);

FIG. 11 is an explanatory diagram showing input data and output data of a machine learning model; and

FIG. 12 is a flowchart showing an operation procedure of an optimal put-in time calculation operation (i.e., an operation for calculating an optimal put-in time).

### DESCRIPTION OF THE PREFERRED EMBODIMENT(S)

Embodiments of a method for creating a machine learning model for estimating a state of a fluid in a tank and a method for estimating a state of a fluid in a tank using a machine learning model according to the present invention will be described with reference to the appended drawing.

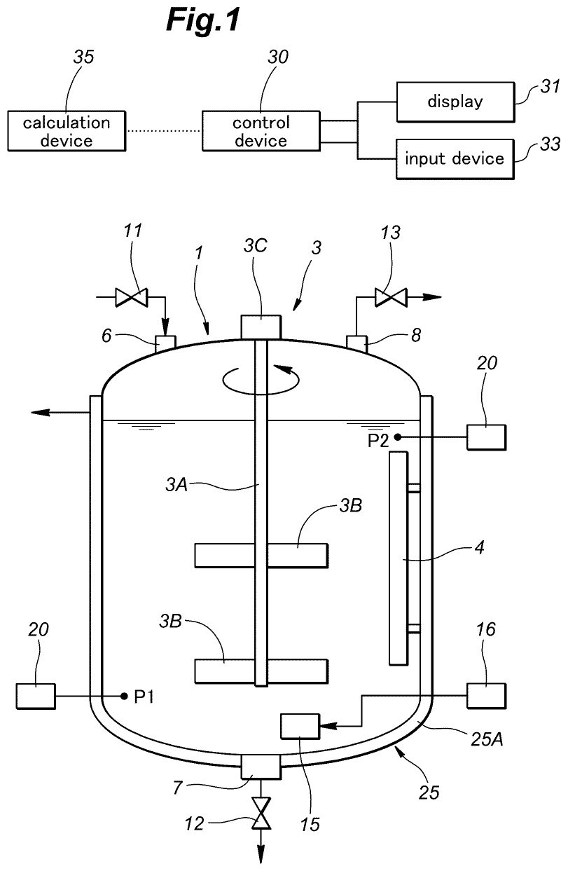

As shown in FIG. 1, a tank 1 may be a culture tank for culturing cells or microorganisms, a reaction tank for causing chemical reactions or biochemical reactions, or a sterilization tank for sterilizing microorganisms. The microorganisms include fungi and protozoa, which are cellular eukaryotes, bacteria, which are cellular prokaryotes, and non-cellular viruses. In the present embodiment, the tank 1 is a culture tank for culturing cells.

The tank 1 may have any shape and size that are determined depending on the purpose. For example, the tank 1 may have a cylindrical shape with an axis extending in the vertical direction. Preferably, the bottom of the tank 1 is shaped to have a curved surface that protrudes downward. Preferably, the top of the tank 1 is shaped to have a curved surface that protrudes upward.

The tank 1 stores fluid therein. In the present embodiment, the fluid includes a culture medium (liquid medium) and cells suspended in the culture medium. The culture medium may be any of a variety of known natural or synthetic culture media. Examples of natural culture media may include LB medium, NB medium, or SCD medium. Synthetic culture media preferably contain carbon sources such as glucose, nitrogen sources such as ammonium salts, sulfur sources, phosphates, and several trace minerals. Synthetic culture media may further contain amino acids, vitamins. The culture medium may be selected according to the cells or microorganisms to be cultured.

The tank 1 is provided with a stirring device 3 for stirring culture fluid. The stirring device 3 preferably includes a shaft 3A, a plurality of stirring blades 3B provided on the shaft 3A, and an electric motor 3C for rotating the shaft 3A. Preferably, the shaft 3A extends vertically in the center of the tank 1. The stirring blades 3B may be of any shape, for example, may be paddle blades or Maxblend blades. The stirring device 3 includes a rotation speed sensor that detects the rotation speed of the shaft 3A.

The inner surface of the tank 1 may be provided with a baffle plate 4 that protrudes toward the center of the tank 1. In other embodiments, the stirring device 3 may be configured to rotate a part or the whole tank 1, thereby stirring the culture fluid.

The tank 1 has a fluid inlet 6 for receiving the culture fluid, a fluid outlet 7 for discharging the culture fluid, and a vent port 8 for discharging gas in the upper part of tank 1. The fluid inlet 6 and vent port 8 are preferably provided at the top of the tank 1. The fluid outlet 7 is preferably provided at the bottom of the tank 1. The fluid inlet 6, the fluid outlet 7, and the vent port 8 are provided with a fluid inlet valve 11, a fluid outlet valve 12, and a vent port valve 13, respectively. The fluid inlet valve 11, fluid outlet valve 12, and vent port valve 13 are flow control valves.

The tank 1 is provided with a sparger 15 that injects gas into the culture fluid at the bottom of the tank 1. The sparger 15 is in fluid communication with a gas supply device 16 outside of the tank 1. The gas supply device 16 supplies a mixture of gases such as air, oxygen gas, carbon dioxide gas, and nitrogen at any ratio. The gas supply device 16 adjusts the amount of gas supplied to the sparger 15.

The tank 1 includes a plurality sensors 20, which include a dissolved oxygen (DO) meter that measures the dissolved oxygen concentration of the culture fluid, a dissolved organic carbon (DOC) meter that measures the dissolved organic carbon concentration of the culture fluid, a pH meter that measures the pH of the culture fluid, a thermometer that measures the temperature of the culture fluid, a fluid pressure gauge that measures the pressure of the culture fluid, a viscometer for measuring the viscosity of the culture fluid, and an electrical conductivity sensor for measuring the electrical conductivity of the culture fluid. Each of the sensors 20 is preferably provided at a first position P1 of the tank 1. In addition, each of the sensors 20 may be provided at a second position P2 of the tank 1. The first position P1 may be, for example, in a lower part of the outer circumference of the tank 1. The second position P2 may be, for example, in an upper part of the outer circumference of the tank 1. Each of the sensors 20 may be further provided at various positions different from the first position P1 and the second position P2.

Provided at the first position P1 of the tank 1 is a first sampling hole. Provided at the second position P2 of the tank 1 is a second first sampling hole. The first and second sampling holes are used to remove the fluid from the tank 1 at the first position P1 and the second position P2, respectively. The first and second sampling holes at the first and second positions P1 and P2 can used to remove samples at the first and second positions P1 and P2, which samples can be measured using various measurement methods such as absorbance measurement and electrical conductivity measurement. The first sampling hole may be in fluid communication with a first return hole of the tank 1 via a first return tube. The sample of fluid flowing through the first return hole may be subject to various measurements, such as absorbance measurement and electrical conductivity measurement. Similarly, the second sampling hole may be in fluid communication with a second return hole of the tank 1 via a second return tube.

The tank 1 is provided with a temperature adjustment device 25. The temperature adjustment device 25 may be a heater or a heat exchanger. In the present embodiment, the temperature adjustment device 25 has a jacket 25A provided on the outer surface of the tank 1. The jacket 25A is supplied with a heat medium having a temperature that is properly adjusted.

The various sensors 20, stirring device 3, gas supply device 16, fluid inlet valve 11, fluid outlet valve 12, vent port valve 13, and temperature adjustment device 25 are connected to a control device 30. The control device 30 is an electronic control device including a processor, a memory, and a storage device that can store programs. The control device 30 is used to execute the programs thereby implementing applications. The control device 30 controls the various devices 3, 16, and 25 and the various valves 11, 12, and 13 based on signals from the various sensors 20. The control device 30 may be directly connected, by wire, to the various sensors 20, the stirring device 3, the gas supply device 16, the fluid inlet valve 11, the fluid outlet valve 12, the vent port valve 13, and the temperature adjustment device 25. The control device 30 may be connected via a communication network. Thus, the control device 30 may be located at a position that is distant from the tank 1. The control device 30 may be formed as a single unit, or consist of a plurality of units that are communicatively connected with each other.

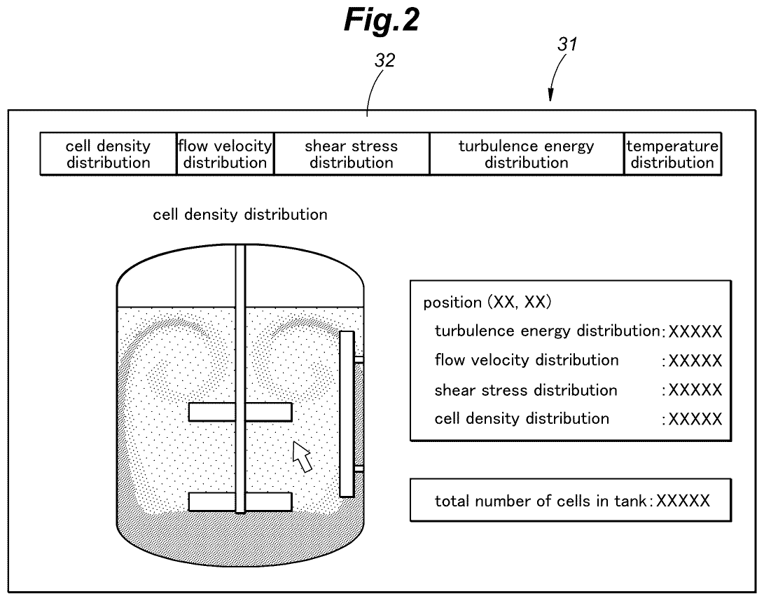

The control device 30 is connected to a display 31. The display 31 may be provided in a mobile terminal capable of communicating with the control device 30. The control device 30 generates an operation screen 32 for the tank 1 to be displayed on the display 31, as shown in FIG. 2. The operation screen 32 displays fluid information, i.e., information on a fluid in the tank 1, as described later. In addition, the operation screen 32 may also display an operating status of each of the devices 3, 16, and 25, as well as detection values measured by the sensors 20.

The control device 30 is connected to an input device 33 that receives input operations of an operator. Examples of the input device 33 may include a keyboard and a mouse. The input device 33 and the display 31 may be formed in a single unit as a touch panel display.

The control device 30 estimates a state of a fluid in the tank 1 by using a machine learning model. The fluid contains a liquid stored in the tank 1 and a substance(s) present in the liquid. The substance(s) may be dissolved in the liquid or not. In the present embodiment, the fluid has a liquid culture medium and cells floating in the culture medium.

The machine learning model for estimating the state of the fluid in the tank 1 is created by the control device 30 or other calculation device 35 prior to the estimation. The calculation device 35 includes a processor, memory, and a storage device that can store programs. The calculation device 35 can execute programs to implement applications. In the present embodiment, the machine learning program is created by the calculation device 35.

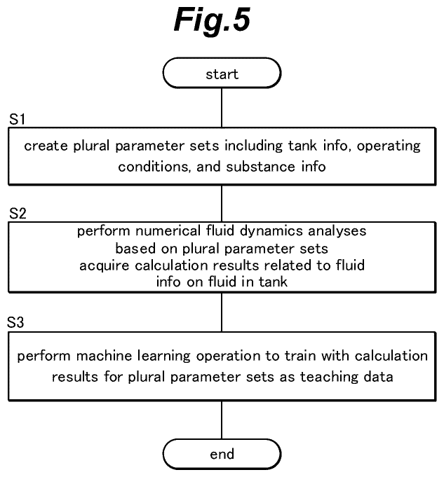

As shown in FIG. 5, the calculation device 35 performs a method for creating a machine learning model for estimating a state of a fluid in the tank 1. The method includes a first step S1 of creating a plurality of parameter sets, each set comprising tank information including at least a shape and size of the tank, operating conditions of the tank, and substance information including at least an amount, and one or more physical properties of each of the plurality of substances, wherein the plurality of parameter sets are created by varying the parameters of the operating conditions and the substance information; a second step S2 of performing a numerical fluid dynamics analysis based on the plurality of parameter sets to provide a plurality of calculation results as fluid information including at least one of (i) distributions of physical quantities related to the fluid and (ii) an amount of each of the plurality of substances; and a third step S3 of creating the machine learning model by a machine learning operation which involves training the machine learning model with teaching data including the plurality of parameter sets and the corresponding plurality of calculation results.

As used herein, “distributions of physical quantities related to the fluid” includes a presence distribution of a fluid, a distribution of each of the substances (e.g., cells) contained in the fluid, a density distribution of each of the substances, a flow velocity distribution, a turbulent energy distribution, a shear stress distribution, a pressure distribution, and a temperature distribution.

In Step S1, a parameter set is created for performing a numerical fluid dynamics analysis of the fluid in the tank 1. The parameter set includes at least tank information, operating conditions of the tank, and substance information including an amount and one or more physical properties of each of the plurality of substances contained in the fluid. A plurality of parameter sets are created and stored as data in the calculation device 35.

The tank information includes at least a shape and size of the tank 1. The tank information includes information required to specify the shape of an inner wall of tank 1, such as the heights, radii, and curvatures of the bottom and top parts of the tank 1. The tank information also includes information on the baffle plate 4, i.e., the height, width, thickness, and position within the tank 1 of the baffle plate 4. The tank information also includes the shape and size of the stirring device 3. The shape and size of the stirring device 3 may include information on the shafts 3A and 3B; that is, the diameter, length, and position of het stirring device 3 within the tank 1 of the shaft 3A, as well as the shape, number, size, and position within the tank 1 of the stirring blade 3B.

The operating conditions preferably include stirring conditions, including the rotation speed and stirring pattern of the stirring device 3, and gas supply conditions. Examples of the rotation pattern of the stirring device 3 may include a case in which the rotation speed changes periodically, a case in which the shaft 3A reciprocates in an axial direction (up-down direction), and a case in which the tank 1 itself rotates. For example, when the shaft 3A of the stirring device 3 reciprocates in the axial direction (up-down direction), the operating conditions may include the stroke length of the shaft 3A and the cycle of the reciprocating motion. The gas supply conditions may include a composition and flow rate of the gas supplied by the gas supply device 16. The composition of the gas may be expressed by a mixing ratio of air, oxygen gas, carbon dioxide gas, and nitrogen gas.

The operating conditions preferably include temperature conditions of the tank 1, as well as a dissolved oxygen (DO) level, a dissolved organic carbon (DOC) level, a pH, a pressure, an hourly supply rate (supply amount), and a supply duration of the fluid. The temperature conditions for the tank 1 may include operating conditions of the temperature adjustment device 25. The operating conditions of the temperature adjustment device 25 include the temperature and flow rate of a heat medium supplied by the temperature adjustment device 25 to the jacket 25A. When a viscosity of the fluid is measured, the temperature conditions for the tank 1 do not need to be included in the operating conditions.

The substance information includes an amount and one or more physical properties of each of the plurality of substances contained in the fluid. In the present embodiment, the substances include a culture fluid and cells. The substance information may include a concentration of cells in the fluid (or the total number of cells in the tank), as well as a viscosity, and specific gravity of the cells of the fluid containing the culture fluid and cells, and a size of a single cell. The substance information may also include the weight of the fluid containing the culture fluid and cells. In other embodiments, some substance information may be registered as product names associated with one or more physical properties thereof, and the method may be configured to enter the product names into the calculation device 35, thereby causing one or more physical properties associated with the product names automatically input into the machine learning model.

In some preferred embodiments, various parameter sets are created by varying the parameters of the operating conditions and the substance information with the unchanged tank information. The operating conditions and substance information are preferably varied within a variable range. For example, the total number of cells in the fluid is preferably variable between the number at the start of culture and a target number at the end of culture.

In Step S2, the calculation device 35 performs a numerical fluid dynamics analysis using the plurality of parameter created in Step S1 as input data. A physical model used for the numerical fluid dynamics analysis may be one that is created using a well-known method. As a preliminary step for the numerical fluid dynamics analysis, the calculation device 35 uses computer-aided design (CAD) technology to create a 2D or 3D model of the tank 1, and then divides a space inside tank 1 into a number of meshes, thereby discretizing the space. In some discretization methods, the operation of dividing the space into meshes may be unused. Discretization methods can be any of suitable well-known methods, such as finite difference methods, finite volume methods, finite element methods, spectral methods, boundary element methods, lattice automata methods, lattice Boltzmann methods, lattice gas methods, adaptive mesh refinement methods, and particle methods. The calculation device 35 repeatedly performs calculations of hydrodynamic equations for the meshes, thereby providing calculation results including the fluid pressure, flow velocity, flow velocity direction, and density (cell density) for each of the meshes. Examples of the hydrodynamic equations may include the Euler equations and the Navier-Stokes equations. The calculation device 35 performs numerical fluid dynamics analyses for each of a plurality of parameter sets to provide a plurality of calculation results.

In Step S3, the calculation device 35 first creates teaching data for a machine learning operation that includes training machine learning models based on the plurality of parameter sets and the corresponding calculation results. The teaching data is formed by records, each record including operating conditions, substance information, and the corresponding calculation results. Examples of data included in the teaching data may include operating conditions, substance information, sets of input data that include information on the fluid at a first position P1 contained in the calculation results, and output data that include all calculation results. The information on the fluid at the first position P1 may include at least one of a pressure, flow velocity, flow velocity direction, and density of the fluid at the first position P1.

The calculation device 35 creates a machine learning model based on the created teaching data. The machine learning model is preferably created in the form of a known neural network model or deep learning model. For input data including the operating conditions, substance information, and fluid information at the first position P1, the machine learning model outputs fluid information, including the pressure, flow velocity, flow velocity direction, and density of the fluid at each position in the tank 1. The machine learning model is created using the above-described operation procedure. In the above-described embodiments, the calculation device 35 performs operations of numerical fluid dynamics analysis, creating teaching data, and creating machine learning model. However, different calculation devices 35 may be used to perform the respective operations.

The created machine learning model is stored in the control device 30. The control device 30 uses the machine learning model to estimate the state of the fluid in the tank 1. The control device 30 inputs first fluid information about the state of the fluid at the first position P1 in the tank 1, the operating conditions, and the substance information to the machine learning model, to thereby output the fluid information as the output of the machine learning model. The first fluid information may include at least one of the fluid pressure, flow velocity, flow velocity direction, and density (cell density) at the first position P1. Examples of the first fluid information may include information related to the number of cells or microorganisms at the first position P1. In the present embodiment, the first fluid information is the cell density of the fluid at the first position P1. The first fluid information may be acquired based on the electrical conductivity of the fluid at the first position P1. In some cases, the first fluid information may also be acquired based on the protein concentration (titer) of the cells. In other cases, the first fluid information may also be acquired by counting the actual number of cells in a sample fluid in the tank. The control device 30 acquires the cell density of the fluid at the first position P1 based on the signal from an electrical conductivity sensor at the first position P1. The control device 30 acquires the operating conditions based on the signals from each of the devices 3, 16, 25 and the sensors 20, or based on data input by an operator. In addition, the control device 30 acquires the substance information based on input information which is input by the operator. The control device 30 acquires the fluid information including the fluid pressure, flow velocity, flow velocity direction, and density at each of the positions in the tank 1, as the output data of the machine learning model.

The control device 30 causes the display 31 to display the output data of the machine learning model. The control device 30 causes the display 31 to display the fluid information (distributions of physical quantities related to the fluid) included in the output of the machine learning model, which includes, for example, the pressure, flow velocity, flow velocity direction, and density of the fluid at each of the positions in the tank 1. Preferably, the fluid pressure, velocity, velocity direction, and density at each of the positions in the tank 1 may be displayed by using a contour map, streamline diagram, or vector diagram. In addition, such images as contour maps, streamline diagrams, and vector diagrams may be displayed as video images that show changes with time. Furthermore, the control device 30 may be configured such that, when a certain position in the image of the tank 1 is specified, the display 31 shows fluid information at the specified position as numerical information.

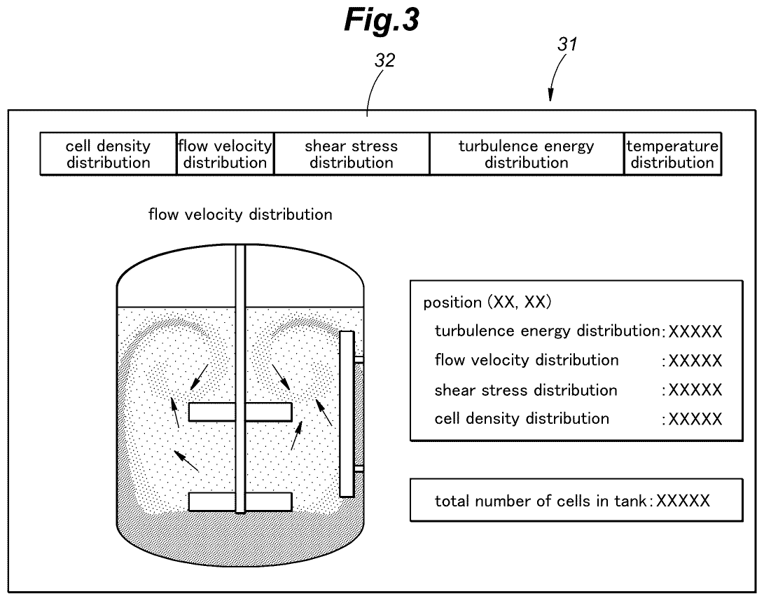

FIGS. 2 and 3 show an example of an operation screen 32 displayed on the display. FIG. 2 is displayed when an operator selects “cell density distribution” from the tabs at the top in the screen. The screen includes also an image or video of the cell density distribution on the left. The image or video shows a cell density distribution with colors indicating levels of the density so that an operator can easily recognize the cell density distribution at a glance. When the operator clicks on a point or area in the image or video with the cursor, the screen shows, on the right side, the physical quantity of the fluid at the point or area. In FIG. 2, the screen numerically displays turbulent energy, flow velocity, shear stress, and cell density of the fluid, as the physical quantities. The screen may display the change (or rate of change) in these values with time based on the accumulation of time series data. The system is also configured to display the total number of cells in the tank, allowing an operator to check the cell culture status. FIG. 3 shows an example of screen when the operator elects “Velocity Distribution” from the tabs at the top. The image or video of the velocity distribution on the left side of the screen shows arrows indicating the direction and magnitude of the velocity. When an operator clicks on the arrows with the cursor, the screen shows the fluid information at each location, in the same way as in FIG. 2.

The control device 30 calculates the total number of cells in the tank 1 based on the output of the machine learning model. For example, the control device 30 may calculate the total number of cells in the tank 1 based on the cell density of the fluid at each position for which the output of the machine learning model is provided. The control device 30 may cause the display 31 to display the operation screen 32 indicating the calculated total number of cells in the tank 1. In other embodiments, the output of the machine learning model may include the total number of cells in the tank 1. In this case, the control device 30 calculates the total number of cells in the tank 1 based on the results of the numerical fluid dynamics analysis for each parameter set. The total number of cells in the tank 1 is included in the teaching data, and the machine learning model is created based on this teaching data.

The control device 30 compares the output values of the machine learning model with the pre-set target value and controls each of the devices 3, 16, 25 and the valves 11, 12, 13.

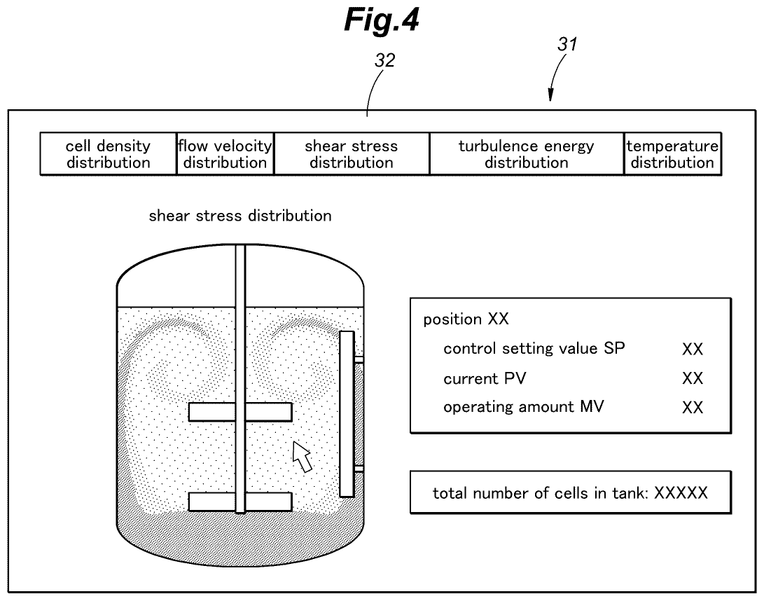

FIG. 4 shows an example of a control screen. As shown in FIG. 4, the screen displays the shear stress distribution, as well as the control setpoint SP (Set Point), the current value (Process Value), and the manipulation value MV (Manipulation Value). The purpose of this example is to control the rotation speed of the stirring device 3 in order to maintain the shear stress value in the tank at an appropriate level. The current value is the shear stress value at a specific position in the tank, based on the output of the machine learning model. Although the specific position can be any position in the tank, the specific position preferably is near the stirring blade 3B, where the shear stress value can be the greatest. The control setting value is a shear stress value that is set by taking into account the one or more physical properties (such as fragility) of the substance (such as cells) in the tank, and it is preferable to maintain the shear stress value at this control setting value during stirring. The manipulation value is a value that is controlled to maintain the current value at the control setting value, and is, for example, a value related to the rotation speed of the stirring device 3. Based on these displayed values, an operator can perform feedback control of the tank. In this way, the control device 30 can determine the current value, the control set value, and the manipulation value based on the real-time fluid information (distribution of physical quantities related to the fluid) output from the machine learning model. For this reason, the control device 30 of the present disclosure is disclosure is also useful for real-time device control.

According to the above-described embodiment, the machine learning model is created using calculation results of a numerical fluid dynamics analysis, which allows for an accurate estimation of a state of a fluid in a tank 1 through the use of the machine learning model. Calculations with the use of the machine learning model require a shorter time than those with the numerical fluid dynamics analysis, which allows for a quick estimation of the state of the fluid in the tank 1. In the prior art, numerical fluid dynamics analysis, which requires a longer time as described above, has been generally used in designing the tank, and has been difficult to allow users to grasp a state of the fluid in the tank on a real-time basis. However, in the present disclosure, a machine learning model which has been pre-trained on the operating state of the tank 1, is constructed so that the machine learning model can quickly output information on the entire tank 1 during operation, which allows users to grasp a state in the device on a real-time basis. In addition, the tank information used in the numerical fluid dynamics analysis is the same as that for the actual tank, which allows for reduction of input data required for calculations with the use of the machine learning model.

In addition, the fluid information at the first position P1 of the actual tank 1 is used as input for the machine learning model, which improves the accuracy of the output of the machine learning model. In particular, the concentration of cells at the first position P1 is used as input for the machine learning model, which improves the accuracy of estimation of the concentration of cells at each position included in the output and the accuracy of the total number that is calculated based on the estimated concentration of cells at each position.

The machine learning model may output calculation results corresponding to the first fluid information. This configuration includes comparing the first fluid information acquired by the sensors 20 or other sensors and the first fluid information output from the machine learning model, allowing the accuracy of the machine learning model to be checked.

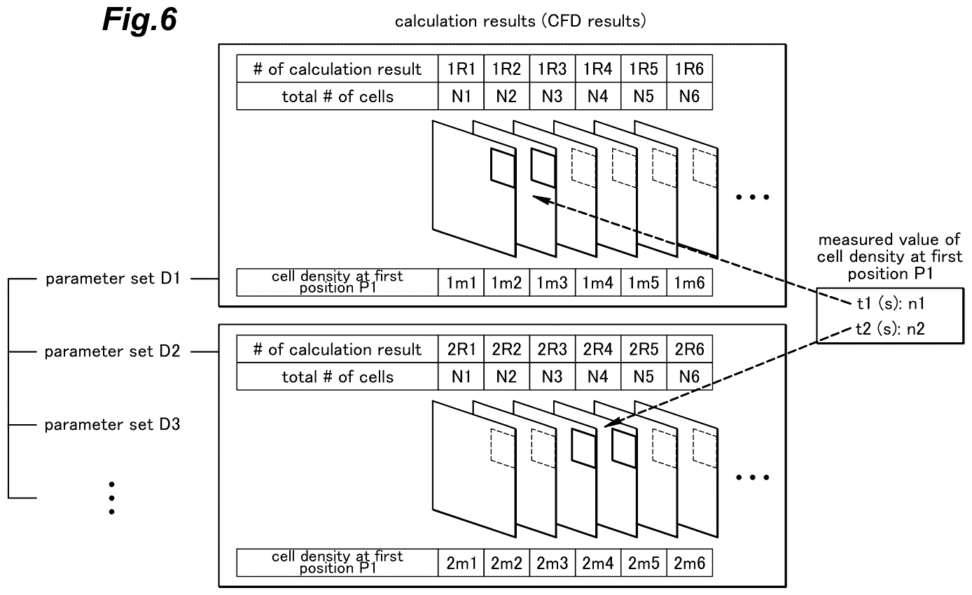

Next, referring to FIG. 6, a method for estimating a state of a fluid in the tank using the estimation model according to one embodiment of the present invention will be described.

First, before the start of stirring the tank 1, the control device 30 acquires, as the operating conditions, the stirring conditions including the rotation speed and stirring pattern of the stirring device 3, and the gas supply conditions, and, as the substance information, the amount and one or more physical properties of the culture fluid and cells contained in the fluid.

Next, t1 seconds after the start of stirring, the control device 30 acquires the cell density n1 at the first position P1 as the first fluid information. Then, the control device 30 inputs the operating conditions (stirring conditions and gas supply conditions), physical-property conditions, and first fluid information to the estimation model. The estimation model is used to identify, from among the plurality of parameter sets, a parameter set D1 that corresponds to or is closest to the input operating conditions and physical-property conditions. The estimation model is further used to: (1) select the calculation result that includes the first fluid information that is the same as the input first fluid information, from among the plurality of calculation results using parameter set D1; (2) select the calculation result that includes the first fluid information that is closest to the input first fluid information, or; (3) generate calculation results that fit the input first fluid information, based on the plurality of calculation results. In the present embodiment, when the actual measured value n1 of cell density at the first position P1 is input to the estimation model, the estimation model outputs (i) a calculation result in which the cell density at the first position P1 is n1, or which is closest to n1, chosen from the calculation results of a plurality of numerical fluid dynamics analyses using the parameter set D1, or (ii) generates a calculation result in which the cell density at the first position P1 is n1.

The plurality of calculation results 1R1 to 1Rn using the parameter set D1 are the results of numerical fluid dynamics analysis calculated assuming that the total number of cells in the tank is each of N1 to Nn, respectively. When, among these calculation results, the calculation results in which the cell density at the first position P1 at the point of t1 seconds after the start of stirring, is closest to n 1, are the calculation result 1R1, in which the total number of cells in the tank is fixed at N1, and the calculation result 1R2, in which the total number of cells in the tank is fixed at N2, the estimation model outputs a calculation result 1R1, a calculation result 1R2, and a calculation result 1Q1 which is newly calculated within the interpolation range between the calculation results 1R1 and 1R2. Concurrently, the estimation model calculates, as the total number of cells in the tank, N1, N2, or N'1 within the interpolation range between N1 and N2. In this configuration, the calculation device 35 can output the calculation results of the numerical fluid dynamics analysis in real time using the estimation model, as well as the total number of cells based on the total numbers of cells in the calculation results in the device in operation in real time.

Next, t2 seconds after the start of stirring, the control device 30 acquires the cell density n2 at the first position P1 as the first fluid information. Then, the control device 30 inputs the operating conditions (stirring conditions and gas supply conditions), physical-property conditions, and first fluid information to the estimation model. When the operating conditions or physical-property conditions are changed during a period from t1 to t2, the estimation model is used to identify a parameter set D2 that corresponds to or is closest to the changed conditions. The estimation model is further used to: (1) select the calculation result that includes the first fluid information that is the same as the input first fluid information, from among the plurality of calculation results 2R1 to 2Rn using parameter set D2; (2) select the calculation result that includes the first fluid information that is closest to the input first fluid information, or; (3) generate calculation results that fit the input first fluid information, based on the plurality of calculation results. In the present embodiment, when the value n2 of cell density at the first position P1 is input to the estimation model, the estimation model outputs (i) a calculation result in which the cell density at the first position P1 is n2, or which is closest to n1, chosen from the calculation results 2R1 to 2Rn of a plurality of numerical fluid dynamics analyses using the parameter set D1, or (ii) generates a calculation result in which the cell density at the first position P1 is n2.

In the same manner as the case of the time t1, when, among the results of numerical fluid dynamics analyses in which the total number of cells in the tank are changed from N1 to Nn, the calculation results in which the cell density at the first position P1 at the point of t2 seconds after the start of stirring, is closest to n2, are the calculation result 2R3, in which the total number of cells in the tank is fixed at N3, and the calculation result 2R4, in which the total number of cells in the tank is fixed at N4, the estimation model outputs a calculation result 2R3, a calculation result 2R4, and a calculation result 2Q1 which is newly calculated within the interpolation range between the calculation results 2R3 and 2R4. Concurrently, the estimation model calculates, as the total number of cells in the tank, N3, N4, or N'2 within the interpolation range between N3 and N4.

As described above, the control device 30 makes a plurality of calculations of the results of numerical fluid dynamics analysis for stirring under the same operating conditions and physical-property conditions, with the total number of cells in the tank varied, and the calculation results are used to train the machine learning model. Even when the total number of cells changes due to biochemical reactions, this configuration allows users to grasp the state in the tank such as the number of cells, without acquiring information about the biochemical reactions (such as reaction rates). Furthermore, this configuration can achieve more accurate calculation of the total number of cells by using parameter sets created with varied measurement values, which can be measured in part of other tanks (e.g., the amount of dissolved oxygen or pH). In the present embodiment, the estimation model is configured to output fluid information based on the prestored calculation results. Thus, although the present invention can be embodied with the use of an estimation model that does not rely on machine learning technology, a machine learning model is preferably used in order to create new fluid information within the interpolation range of the stored calculation results. When the estimation model is a machine learning model, the machine learning model is trained using substance information including operating conditions and the amount and one or more physical properties of a plurality of substances contained in the fluid as an explanatory variable, and a group of calculation results for parameter sets D1, D2, D3 as teaching data, and, in response to input of the first fluid information, the total number of cells in the tank that matches the cell density at the first position P1 is regressed, and the machine learning model outputs various substance information (e.g. information on a distribution of the physical quantity of the fluid) that matches the operating conditions of the tank and the regressed total number of cells.

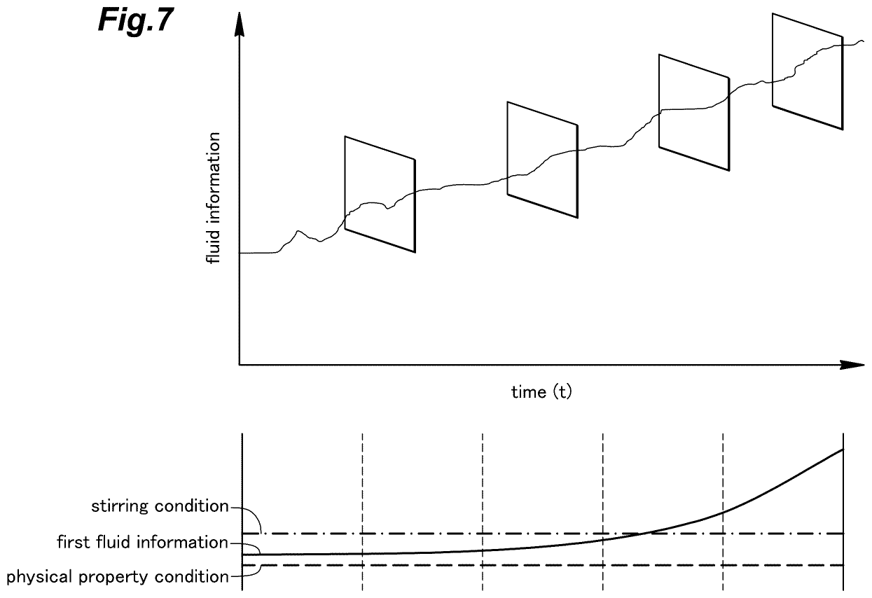

Next, a method for estimating a state of a fluid in a tank using a machine learning model according to a second embodiment of the present invention will be described with reference to FIG. 7. In the second embodiment, the machine learning model is a regression model, which is trained using a parameter set and calculation results of a numerical fluid dynamics analysis as teaching data, and is weighted for each parameter so as to derive calculation results that match a given parameter set.

First, before the start of stirring the tank 1, the control device 30 acquires the operating conditions, including the stirring conditions, such as the rotation speed and stirring pattern of the stirring device 3, and the gas supply conditions, and also acquires the substance information including the amount and one or more physical properties of the culture fluid and cells contained in the fluid, and inputs the acquired data to the machine learning model. In this way, the control device 30 calculates and outputs the fluid information in the tank for the input parameters.

Once the stirring starts, the time that has elapsed since the start of the stirring (the time and date) is time-synchronized with the machine learning model, so that the machine learning model can output the fluid information in the tank at each time in real time.

The stirring of a fluid containing cells and culture medium allows the cells to be cultured and the number of cells in the tank increases. However, the above parameters are insufficient to track the increase in the number of cells after the start of string and reflect the increase in the number in the calculation results.

In the present embodiment, the machine learning model acquires the cell density n1 at the first position P1 as the first fluid information from the stirring device 3, and outputs the calculation result that reflects this information. In some cases, the total number of cells in the entire tank may be sensed or sampled as an input parameter for machine learning. However, when the stirring device 3 is in operation, it is difficult to sense and sample the total number of cells. Thus, one available simpler method is to locally acquire information on the number of cells (such as the number of cells, cell density) in an area about a point in the tank (first position 1, P1) in the tank. In a cell culture, the number of cells increases after the start of stirring, which means that the cell density n1 at the first position P1 at a point of t1 seconds after the start of stirring should be higher compared to the case where a numerical fluid dynamics analysis is performed on the assumption that the number of cells does not increase. Thus, by acquiring the cell density n1 at the first position (P1) in operation, the pace of cell growth can be reflected in the calculation results. For example, on the assumption of the presence of 1000 cells present before the start of stirring, then after t1 seconds have passed from the start of stirring, the cell density at the first position (P1) is 100 and the number of the cells has not increased, and when the cell density sensed as the first fluid information is 200, assuming that the cell density in the tank, other than in the first position P1, has also doubled, the machine learning model can calculate the cell distribution in the entire tank and the distribution of other physical quantities (such as shear stress distribution and flow velocity distribution) based on the cell distribution. It should be noted that this is a simplified example, and in reality, the machine learning model can output fluid information by taking into account many other parameters such as dissolved oxygen and pH.

In the above-described embodiments, the first fluid information is acquired continuously after the start of stirring and used for calculations in the machine learning model. However, in other embodiments, the first fluid information may be acquired intermittently after the start of stirring and used for calculations in the machine learning model. In the case that the first fluid information may be acquired intermittently after the start of stirring, the machine learning model is configured such that the fluid information has been regressed based on the operating conditions and physical-property conditions, and the regressed fluid information is further regressed based on the intermittently acquired first fluid information, to provide resultant fluid information, to be output from the machine learning model.

Various modifications can be made to the present embodiments. For example, the input to the machine learning model may be changed depending on the purpose of use thereof. For example, in addition to the first fluid information about a state of the fluid at the first position P1 in the tank, the operating conditions, and the substance information, the tank information may be input to the machine learning model. In this case, the machine learning model is preferably trained using teaching data in which the tank information is changed to various values. Specifically, in the creation of a plurality of parameter sets in Step 1, the parameter sets are preferably created with different tank information without fixing the tank information; i.e., by varying the tank information in the same way as the operating conditions and substance information. Then, numerical fluid dynamics analyses are performed for each of the plurality of parameter sets with varied tank information in Step 2 to provide a plurality of calculation results. Teaching data is created based on a plurality of parameter sets and the corresponding calculation results. Each of the records forming the teaching data contains tank information, operating conditions, substance information, and the corresponding calculation results. Examples of records in the teaching data may include input values that contain tank information, operating conditions, substance information, and information on the fluid at the first position P1 contained in the calculation results, and output values that contain all calculation results. The machine learning model created using this teaching data, in response to input data that includes tank information, operating conditions, substance information, and fluid information at the first position P1, outputs fluid information, including the pressure, flow velocity, flow velocity direction, and density of the fluid at each position in the tank 1. This configuration can provide a machine learning model that corresponds to the tank 1, which has any of the various shapes and sizes.

In other embodiments, the machine learning model may output fluid information including each record of position in the tank 1, for input data that includes operating conditions, substance information, and first fluid information, which are included in fluid information at the first position P1, and second fluid information, which is fluid information at the second position P2. As in the first fluid information, the second fluid information may be the pressure, flow velocity, flow velocity direction, density, dissolved oxygen (DO) concentration, dissolved organic carbon (DOC) concentration, pH, temperature, viscosity, and electrical conductivity of the fluid or substances contained in the fluid at the second position P2. The second fluid information is preferably information related to the number of cells or microorganisms at the second position P2. Examples of teaching data for creating this machine learning model may include operating conditions, substance information, input data that includes fluid information at the first position P1 contained in the calculation results and fluid information at the second position P2 contained in the calculation results, and output data that includes all calculation results. In this configuration, calculations are performed based on the first fluid information and second fluid information on the state of the fluid in the first position P1 and second position P2 in the tank 1, which allows for a more accurate estimation of the state of the fluid in the tank 1.

In other embodiments, the plurality of sensors 20 may include a carbon dioxide gas concentration meter provided in the vent port 8. The carbon dioxide gas concentration meter measures the carbon dioxide gas concentration of the gas discharged from the vent port 8. The fluid information in the tank 1 may include information about the gas discharged from the vent port 8. The substance information may include the carbon dioxide gas concentration in the gas discharged from the vent port 8.

In some cases, the machine learning model may output fluid information at each position in the tank 1 for input data that include operating conditions, substance information, first fluid information, which is fluid information at the first position P1, and the carbon dioxide gas concentration in the gas discharged from the vent port 8. Examples of the teaching data for creating this machine learning model may include tank conditions, operating conditions, substance information, input data that include fluid information at the first position P1 contained in the calculation results and the carbon dioxide gas concentration of the gas discharged from the vent port 8, and output data that includes fluid information at each position in the tank 1 acquired by performing numerical fluid dynamics analyses. In this configuration, calculations are performed based on actual measurements of the first fluid information related to the state of the fluid at the first position P1 in the tank 1 and actual measurements of the carbon dioxide gas concentration in the gas discharged from the vent port 8, which allows for a more accurate estimation of the state of the fluid in the tank 1.

In other embodiments, the first fluid information may be the dissolved oxygen (DO) concentration, dissolved organic carbon (DOC) concentration, pH, temperature, pressure, viscosity, or electrical conductivity of the fluid at the first position P1.

In the above-described embodiment, the tank 1 is a culture tank and the fluid is a culture solution and cells. In other embodiments, the cells may be replaced with microorganisms such as fungi, protozoa, bacteria, and viruses. When the tank 1 is a sterilization tank, the fluid may contain a liquid such as water, microorganisms such as fungi, protozoa, bacteria, and viruses, and a sterilizing agent. When the tank 1 is a reaction tank, the fluid may contain a solvent, at least one raw material, and at least one reaction product.

When microorganisms are used in place of cells, the fluid in the tank 1 contains a culture medium, microorganisms, and metabolites produced by the microorganisms. When a machine learning model is created for monitoring the growth of microorganisms, teaching data preferably include records for different total numbers of microorganisms in the tank 1. This configuration preferably includes creating a plurality of parameter sets for different total numbers of microorganisms in the tank 1, and performing numerical fluid dynamics analyses for the plurality of parameter sets to provide a plurality of calculation results, and creating teaching data for machine learning based on the plurality of parameter sets and the corresponding calculation results.

When a machine learning model is created for monitoring the growth of microbial metabolites, teaching data preferably include records for different total numbers of microbial metabolites in the tank 1. This configuration preferably includes creating a plurality of parameter sets for different total numbers of microbial metabolites in the tank 1, and performing numerical fluid dynamics analyses on the multiple parameter sets to provide a plurality of calculation results, and creating teaching data for machine learning based on the plurality of parameter sets and the corresponding calculation results.

The machine learning model may, in response to input data that includes operating conditions, substance information, and first fluid information, which is fluid information on the first position P1, output fluid information for each position in the tank 1. The first fluid information preferably includes the density of microorganisms or metabolites at the first position. The fluid information for each position in the tank 1 as an output of the machine learning model may include at least one of the fluid pressure, flow velocity, flow velocity direction, microbial density, metabolite density, turbulent energy, and shear stress for each position in tank 1. The microbial distribution in the tank 1 may be acquired from the microbial density for each position in the tank 1. The metabolite distribution in the tank 1 may be acquired from the metabolite density for each position in the tank 1.

In other embodiments, each of the parameter sets for numerical fluid dynamics analysis may include additional substance information. The additional substance information may include the amount and one or more physical properties, put-in time, put-in position, and put-in rate of the additional substance.

An additional substance is a substance that is added to the fluid in the tank 1 after the start of operation of the tank 1. The additional substance may be a vector such as a plasmid that reacts with the cells in a culture. Examples of the additional substance may include:
a specific substance such as an enhancer or booster that increases the efficiency of transfection or an inhibitor that stops transfection; a carbon source such as glucose; a nitrogen source such as ammonium salt; a sulfur source; phosphate, and several trace minerals; calcium salts to adjust the pH; and specific substances such as antifoam agents (surfactants), where the antifoam agents prevent the formation of bubbles by inhibiting the stabilization of the thin film that forms when bubbles in a liquid rise to the surface of the liquid. The additional substance does not include a substance such as oxygen, which is always supplied to the culture tank when the tank 1 is a culture tank. A put-in time of the additional substance is expressed as the elapsed time from the start of operation of the tank 1. A put-in position of the additional substance is the position in the tank 1 where the additional substance is put in. A put-in position of the additional substance is the position in the tank 1 where the additional substance is put in. An example of the put-in position may be the fluid surface directly below the fluid inlet 6, and an example of a put-in direction may be downward. In other words, the additional substance may be put into the tank 1 via the fluid inlet 6. The additional substance may be put in a plurality of times. In some cases, the composition of the additional substance to be put in may be changed each time.

The calculation device 35 may perform the following operations according to the method for creating a machine learning model shown in FIG. 5; which include:
a first step S1 of creating a parameter set that includes tank information, operating conditions of the tank 1, substance information, and additional substance information; a second step S2 of performing a numerical fluid dynamics analysis based on the plurality of parameter sets to acquire a plurality of calculation results as fluid information, which are distributions of physical quantities of the fluid in the tank 1; and a third step S3 of creating a machine learning model by performing machine learning using the plurality of parameter sets and the corresponding calculation results as teaching data. The machine learning model created by this method can output fluid information (distributions of physical quantities related to the fluid) including the pressure, flow velocity, flow velocity direction, and density of the fluid at each position in the tank 1, as well as fluid information after the addition of an additional substance.

The control device 30 may perform operations to output a put-in Y/N indication indicating whether or not an additional substance is allowed to be added to the fluid in the tank 1, or an optimal put-in indication indicating optimal put-in conditions, together with the fluid information on the fluid in the tank 1 in operation. The following example assumes that the tank 1 is a culture tank for culturing cells, and that substances present in the tank 1 from the start of operation are cells and culture fluid, and that an additional substance is a plasmid vector. The plasmid vector, which is the additional substance, is added during operation of the tank 1, and introduced into a cell in the tank 1 to be a viral vector. After a certain period of time has passed, the viral vectors produced in the cells break through the cell membrane and are released outside the cells. This means that, when being released outside the cells, the viral vectors may block contact between plasmid vectors and other cells, preventing the plasmid vectors from being absorbed by the other cells. Thus, formed in the culture tank is a very complicated flow field in which the viral vectors coexist with the cells, the culture medium and the additional substance, making it difficult to estimate a state of the fluid. Therefore, it is desirable that, before the time from when the first cell comes into contact with a plasmid vector to when the viral vector is released outside the cell (hereinafter referred to as “viral vector residence time”) has passed, the plasmid vectors are allowed to be diffused so that almost all of the cells in the culture tank come into contact with the plasmid vectors. In order to achieve this, an additional substance diffusion time, which is a time required for the additional substance to diffuse to every position in the tank, is less than the virus vector residence time. Accordingly, it is important to grasp (i) whether or not an additional substance can be added to the tank 1, or (ii) optimal put-in conditions.

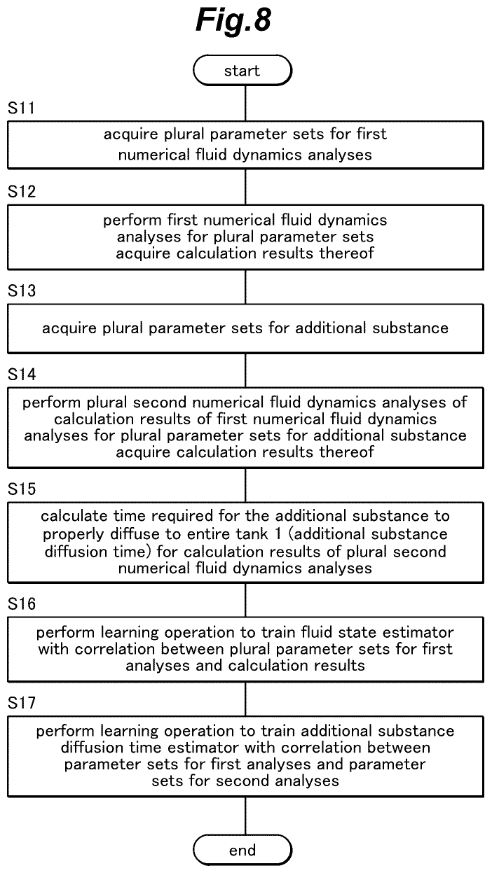

Next, referring to FIG. 8, an operation procedure for creating a machine learning model that outputs a put-in Y/N indication or an optimal put-in indication, together with the fluid information on the fluid in the tank 1 will be described.

The control device 30 first acquires parameter sets for the first numerical fluid dynamics analyses (S11). The parameter sets for first numerical fluid dynamics analyses include tank information on the culture tank, operating conditions, and substance information. The tank information includes the height, radius, curvature of the bottom and top of the culture tank for which an estimation model is to be created. The operating conditions include a rotation pattern, rotation speed, gas supply condition, and temperature condition of the stirring device 3. The substance information includes the total amount and physical properties (viscosity, specific gravity, size) of the cells and the amount and physical properties (viscosity and specific gravity) of the culture fluid.

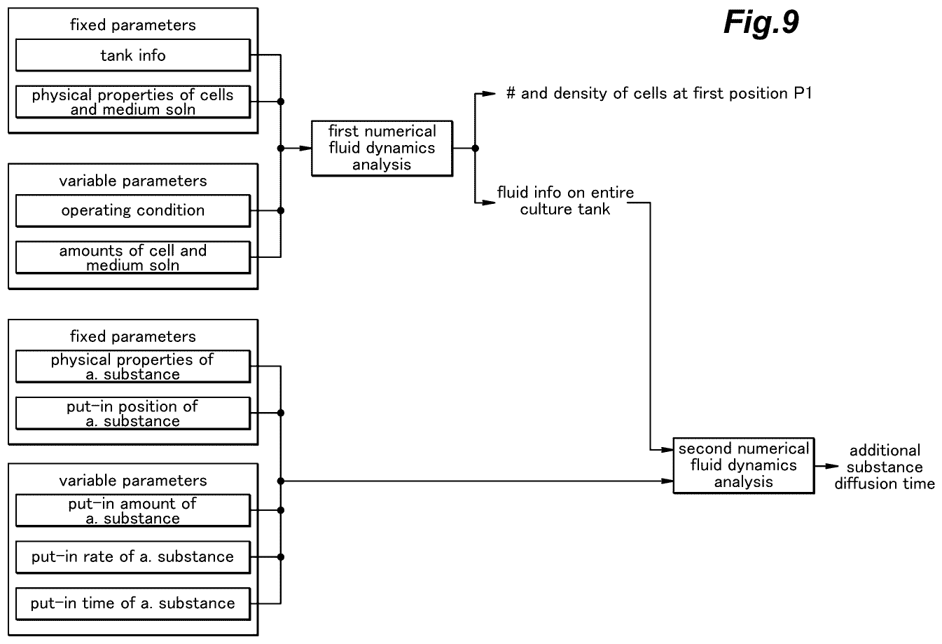

FIG. 9 shows an example of input and output information for the first and second numerical fluid dynamics analyses described below. Assuming that specific cells are cultured using specific culture fluid in a specific culture tank, fixed parameters in the above parameter set are the tank information and the physical properties of the cells and culture fluid included in the substance information. These parameters are used as fixed parameters when performing the first numerical fluid dynamics analysis. The rest of parameters, that is, the operating conditions, total number of the cells, and amount of culture fluid are used as variable parameters, and the first numerical fluid dynamics analysis is performed for a plurality of patterns of variable parameters.

Next, the control device 30 performs the first numerical fluid dynamics analyses using the plurality of parameter sets acquired in S11, and acquires the calculation results of the plurality of first numerical fluid dynamics analyses (S12). For each pattern, fluid information including the fluid pressure, flow velocity, flow velocity direction, and density of each position in the culture tank is acquired as the plurality of calculation results. In the first numerical fluid dynamics analysis, fluid information is generated over time for each parameter set, from the start of operation (i.e., the start of stirring and gas supply) until no change occurs in the distribution of each physical quantity.

Next, the control device 30 acquires a plurality of parameter sets for the additional substance (S13). The parameters for the additional substance may include the amount, physical properties, put-in time, put-in position, and put-in rate of the additional substance. When the additional substance to be added to the culture tank has been specified, the physical properties of the additional substance are fixed parameters (FIG. 9). In addition, when the put-in position of the additional substance is limited by the structure of the culture tank, the put-in position is also set as a fixed parameter (FIG. 9). When these two are set as fixed parameters, the amount of the additional substance, put-in time, and put-in rate are acquired in a plurality of patterns (sets) of variable parameters (FIG. 9). However, when there are a plurality of candidates for the substance to be added, or when there are a plurality of put-in positions for the structure of the tank 1, the physical properties and the put-in position of the additional substance may be set as variable parameters.

In one example, the amounts of additional substance are determined based on the total number of cells. For example, for the first numerical fluid dynamics analysis where the total number of cells is set to N4, performed are a plurality of patterns of the second numerical fluid dynamics analysis of the amounts of additional substance equivalent to or greater than the total number of cells (i.e., N4 or more additional substances). In addition, patterns of the amounts of the additional substance may be set based on the mass (g) of the required additional substance per 1 g of the cells.

The put-in rates of the additional substance are set in a plurality of patterns for the determined amounts of additional substance, and a second fluid dynamics analysis is performed. For example, when the amount of additional substance is N4, the second numerical fluid dynamics analysis is performed with put-in rate patterns such as N4/10 particles per second, N4/5 particles per second, N4 particles per second. In addition, when the amount of additional substance is set in terms of mass (g) per 1 g of cells, the put-in rate of the additional substance is set in a plurality of patterns in units of g/second.

The put-in times for the additional substance are set as a plurality of times, based on the start of operation in the first numerical fluid dynamics analysis. For example, in the first numerical fluid dynamics analysis, six patterns of times are set for putting in the additional substance at 10 minutes, 20 minutes, 30 minutes, 40 minutes, 50 minutes and 1 hour after the start of operation. Note that each time is not the time required for analysis, but rather the time based on the real-time scale of the analysis. The put-in time is preferably set until the time when the fluid state (distributions of physical quantities) is assumed to be constant (i.e., the fluid is completely mixed) in the first fluid dynamics analysis. However, in the first numerical fluid dynamics analysis, when not enough time has passed since the start of operation for the fluid state in the tank to have become constant (for example, 10, 20, or 30 minutes after the start of operation in the above example), these times are not considered to be the times at which the additional substance is to be added. Thus, put-in times may be set such that these times are not set as the put-in times, and only the times which are considered when the fluid has become close to a mixed state to a certain extent (for example, 40 minutes, 50 minutes, and one hour after the start of operation in the above example) are set as the put-in times for additional substance.

Next, the control device 30 performs the second numerical fluid dynamics analyses of the calculation results of the plurality of first numerical fluid dynamics analyses for each of the plurality of parameter sets related to additional substances, and acquires the calculation results of the plurality of second numerical fluid dynamics analyses (S14).

Furthermore, the control device 30 calculates a time required for the additional substance to diffuse properly to each position in the culture tank (additional substance diffusion time) based on the calculation results of the plurality of second numerical fluid dynamics analyses (S15). The expression “to diffuse properly to each position in the culture tank” refers to, for example, a state where the distribution of the additional substance is properly equivalent to the distribution of the cell concentration in the culture tank. In other words, the control device 30 derives the distribution of the cell concentration at the time of the additional substance put-in from the first numerical fluid dynamics analysis, and identifies, as the additional substance diffusion time, the time required for the concentration distribution of the additional substance to reach a state in which the distribution can be evaluated as being equivalent to the cell concentration distribution after the addition of the additional substance. In another example, the expression “to diffuse properly to each position in the culture tank” refers to a state in which the concentration distribution of the additional substance is evenly distributed across the entire culture tank. In this way, the control device 30 calculates the additional substance diffusion time in the second numerical fluid dynamics analysis for each pattern.

Next, the control device 30 creates an estimation model based on the used parameter sets and acquired calculation results in the first numerical fluid dynamics analysis and the used parameter sets and acquired additional substance diffusion times in the second numerical fluid dynamics analysis. The estimation model includes a block for estimation of fluid state and a block for estimation of additional substance diffusion time (hereinafter also referred to as “fluid state estimator” and “additional substance diffusion time estimator”).

First, the control device 30 performs a learning operation to train the fluid state estimator with correlations between the used parameter sets and acquired calculation results in the first numerical fluid dynamics analysis (S16). The fluid state estimator estimates the fluid state in the culture tank before the addition of additional substance. The parameter sets for the first numerical fluid dynamics analysis which are used for the learning operation for the fluid state estimator include tank information operating conditions, and physical properties of the cells and culture medium. Preferably, for the use of the estimation model in later estimation operations, the fluid state of the first position P1 of the culture tank (preferably, the number of cells or cell density at the first position P1) is extracted from the calculation results of the first numerical fluid dynamics analyses, and the fluid state estimator is trained with the correlations between the used parameter set in the first numerical fluid dynamics analysis and the calculation results for each position in the culture tank. The parameter set for the first fluid dynamics analysis includes the total number of cells and the amount of culture fluid, which are difficult to be acquired by actual measurements of the fluid in the tank during operation. Thus, it is preferable that these parameters are not used as explanatory variables in training the fluid state estimator, but used in training as objective variables for the parameter sets in other first numerical fluid dynamics analyses.

Next, the control device 30 trains the additional substance diffusion time estimator with correlations between the parameter sets used for the first numerical fluid dynamics analyses, the parameter sets used for the second numerical fluid dynamics analyses and the additional substance diffusion times (S17). Specifically, the additional substance diffusion time estimator is preferably trained by using, as explanatory variables, the tank information on the culture tank, the operating conditions, the physical properties of the cells and culture fluid, the number or density of cells at the first position P1 of the culture tank, as well as the physical properties, put-in position, put-in amount, put-in rate, and put-in time of the additional substance, and using the additional substance diffusion time as the objective variables. The above-described process steps provide a machine learning model that includes a fluid state estimator and an additional substance diffusion time estimator.

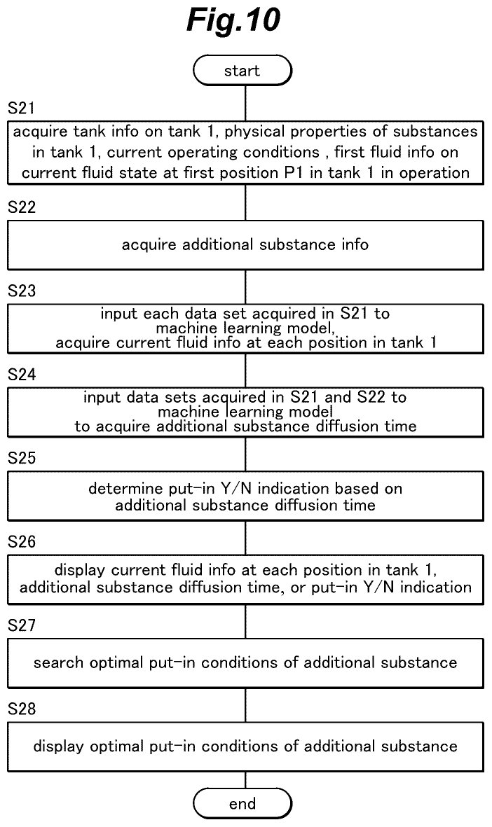

Next, a method for estimating a fluid state in the culture tank during operation, whether or not an additional substance is allowed to be added, and optimal put-in conditions (FIG. 10) will be described, where the method being performed with the use of a machine learning model created by the operation procedure for creating the model shown in FIG. 8.

First, the control device 30 acquires tank information on the tank 1 during operation, the physical properties of substances in the tank 1, current operating conditions, and first fluid information related to the state of a fluid at the first position P1 in the tank 1 (S21). The tank information and physical properties may be set based on an operator's input, or automatically acquired from a database or any other storage storing data regarding the tank information and physical properties. The control device 30 may acquire the tank information and physical properties before the start of operation of the tank 1. The current operating conditions may be set based on an operator's input, or automatically acquired from measuring devices or control devices provided in various devices (stirring device 3, sparger 15). The first fluid information on the current state of the fluid at the first position P1 in the tank 1 is acquired by actual measurements of the tank 1 during operation.

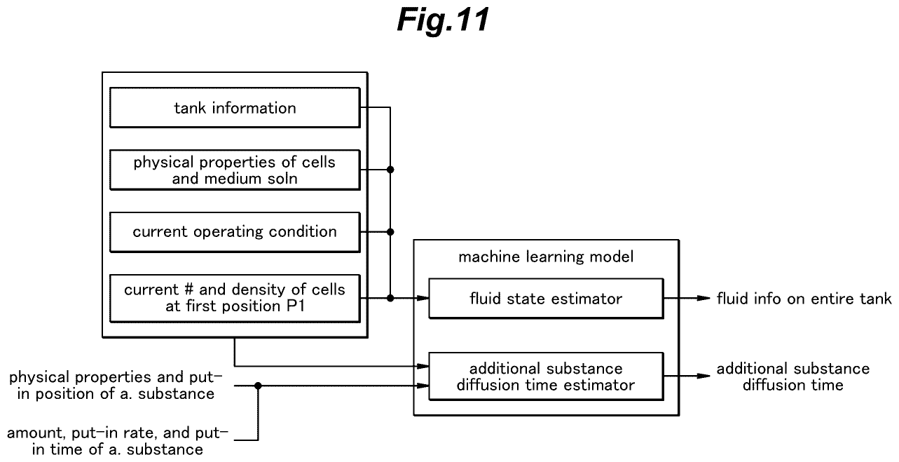

FIG. 11 shows an example of input and output data of a machine learning model. In FIG. 11, the substances are cells and culture fluid, and the first fluid information is the number of cells or cell density at the first position P1. After the culture tank starts operating, the number of cells increases with time. In order to output a fluid state that reflects the increase in the number of cells using the estimation model, the fluid state estimator is configured such that, upon receiving the input of the actual measured values of the concentration or the number of cells at the first position (P1) in the culture tank during operation, the fluid state estimator is able to output the corresponding fluid information on each position in the culture tank 1. The concentration or number of cells at the first position P1 in the culture tank during operation may be directly input by an operator, or automatically acquired from the measuring devices. Furthermore, when the operating conditions are changed during operation, the fluid state estimator receives the input of changed operating conditions and outputs a corresponding fluid state of each position in the culture tank. In this way, the machine learning model is allowed to output the fluid state of each position in the culture tank during operation on a real-time basis, the fluid state reflecting the effects of cell growth and changes in operating conditions.

Next, the control device 30 acquires information about an additional substance based on the operator's input operation (S22). Information about the additional substance includes, for example, the amount, physical properties, put-in position, put-in rate, and put-in time of the additional substance. Of the amount, physical properties, put-in position, put-in rate, and put-in time of the additional substance, those with predetermined values may be input by an operator before the operation of the tank 1, or preset to eliminate the need for the operator's input. When the control device outputs an indication indicating whether or not an additional substance is currently allowed to be added, the put-in time is set to be the current time.

Next, the control device 30 inputs the data set acquired in step S21 in the machine learning model, and acquires current fluid information corresponding to the data set, including the fluid pressure, flow velocity, flow velocity direction, and density at each position in the tank 1, as the output of the machine learning model (S23). In the example shown in FIG. 11, the control device 30 inputs data to the fluid state estimator of the machine learning model, input data including the tank information, the physical properties of the cells and culture medium, the current operating conditions, and the current number or density of cells in the first position P1, and acquires the fluid information for the entire culture tank as the output.

Next, the control device 30 inputs the data set acquired in steps S21 and S22 to the machine learning model, and acquires a corresponding additional substance diffusion time as the output of the machine learning model (S24). In the example shown in FIG. 11, the control device 30 inputs the tank information, the physical properties of the cells and culture fluid, the current operating conditions, the current number or density of the cells at the first position P1, as well as the physical properties, put-in position, amount, put-in rate, and put-in time of the additional substance, to the additional substance diffusion time estimator of the machine learning model, and acquires the additional substance diffusion time as the output of the machine learning model.

Next, the control device 30 determines whether or not the additional substance is allowed to be added based on the additional substance diffusion time (S25). The determination of whether or not the additional substance is made based on whether or not the additional substance diffusion time output from the machine learning model is within a preset upper limit value for the additional substance diffusion time. The upper limit value for the additional substance diffusion time may be input by an operator.

Next, the control device 30 displays the current fluid information for each position in the tank 1 and the additional substance diffusion time or a put-in Y/N indication indicating whether or not an additional substance is allowed to be added (S26). This allows an operator to check the current fluid information for each position in the tank 1. Furthermore, this configuration allows the operator to check the additional substance diffusion time or whether or not an additional substance is allowed to be added, which is output together with the fluid state for each position in the tank 1, and recognize whether or not an additional substance can be added.

Then, when the displayed additional substance diffusion time is less than the upper limit, when the put-in Y/N indication indicates “No”, or when it is necessary to determine better conditions of the additional substance put-in position, put-in rate, and put-in time (i.e., better conditions providing a shorter diffusion time), the control device 30 performs a step of searching for optimal put-in conditions for the additional substance (S27).

In this case, the control device 30 is preferably provided with a put-in condition searcher for searching put-in conditions. The put-in condition searcher inputs a plurality of patterns of the operating conditions, number of cells, amount, put-in time, put-in rate, or put-in position of the additional substance at the first position P1, to the fluid state estimator and additional substance diffusion time estimator of the machine learning model, and searches for conditions that are equal to or less than a desired additional substance diffusion time. When some of the parameters are constant or predetermined, the put-in condition searcher searches for conditions that result in a diffusion time of less than the desired additional substance diffusion time, for the plurality of patterns in which parameters other than the predetermined parameters are varied while fixing the predetermined parameters.

The put-in condition searcher first inputs the operating conditions that are virtually changed based on the current operating conditions of the culture tank, to the fluid state estimator, and then acquires the corresponding fluid states. Preferably, the put-in condition searcher acquires future states for a plurality of times (for example, one hour, two hours, and three hours after the operating conditions are changed). The put-in condition searcher may be configured to acquire future fluid states when operating conditions are not changed. For each case where the operating conditions have been changed, the put-in condition searcher may be configured to also acquire the fluid state (e.g., the number or density of cells) at the first position P1 for each position in the tank 1 when the fluid state is varied. However, when it is difficult to identify the trend of cell growth and future point of time, the put-in condition searcher does not need to acquire fluid states for cases where the number of cells at the first position P1 is varied. When a prediction period for the additional substance put-in time is sufficiently short compared to the cell growth rate (for example, when a predicted time is a few minutes from the present), the put-in condition searcher may perform a search operation on the assumption that the total number of cells is constant.

Next, the put-in condition searcher calculates an additional substance diffusion time when additional substance is put in at each of the times for the operating conditions output from the fluid state estimator. The put-in condition searcher inputs the operating conditions, the elapsed time after the operating conditions have been changed (equivalent to the additional substance put-in time), the amount, put-in rate, and put-in position of the additional substance to the additional substance diffusion time estimator to acquire the additional substance diffusion time.

The put-in condition searcher outputs the conditions (operating conditions, fluid state at the first position p1, or additional substance put-in conditions) that satisfy the desired additional substance diffusion time as a result of the search. When there are a plurality of patterns of conditions that satisfy the desired additional substance diffusion time, the put-in condition searcher may output all the patterns of conditions, or output the conditions that result in the shortest additional substance diffusion time.

Next, the control device 30 displays the operating conditions, the fluid state at the first position P1, and the additional substance put-in conditions acquired as a result of the above-described search, as optimal put-in conditions for the additional substance. This allows an operator to recognize how the operating conditions are changed and when and how much additional substance is to be put in the fluid in the future and from which input port.

In some cases, it is required to add plasmid vectors to the fluid in the culture tank in operation to thereby produce virus vectors by a specific date, to achieve a virus vector production plan, for example. For example, when it is necessary to know an optimal put-in time to add the plasmid vector to the fluid, in order to produce a virus vector within 10 hours for a culture tank in operation, the put-in condition searcher first inputs a plurality of patterns of changeable operating conditions to the fluid state estimator, acquires the output of the fluid state within 10 hours after the change of the operating conditions, and acquires the additional substance diffusion time for each pattern from the additional substance diffusion time estimator. The control device 30 displays the operating conditions, the put-in position, put-in time, put-in amount and put-in flow rate of the additional substance that result in the shortest additional substance diffusion time. This allows an operator to grasp the optimal put-in time, amount, flow rate and position where the plasmid vector is put in, as well as the operating conditions therefor.

The control device 30 may display the determined optimal put-in time on the display 31. When an additional substance is added through the fluid inlet 6, the control device 30 may control the fluid inlet valve 11 to add the additional substance at the optimal put-in time.

The processes shown in FIGS. 8 and 10 may be implemented without some of the steps. For example, in the process shown in FIG. 10, the steps of searching for and displaying optimal put-in conditions for the additional substance in S27 and S28 may be omitted. In other cases, the steps of determining whether or not an additional substance is allowed to be put in S25 and indicating the additional substance diffusion time or the put-in Y/N indication S26 may be omitted.

In the above-described embodiment, the additional substance diffusion time derived from the calculation results of the second numerical fluid dynamics analyses is used as teaching data and configured as the output of the machine learning model. However, this configuration may be modified such that the calculation results of the second numerical fluid dynamics analyses, i.e. the state of the fluid at each position in the tank 1 after the addition of the additional substance, are used as teaching data and configured as the output of the machine learning model. This allows the states of the fluid in the tank during operation after the addition of the additional substance to be estimated and visualized.

In other embodiments, substance information contained in parameter sets for numerical fluid dynamics analyses may include information on an additional substance. The additional substance information may include the amount and physical properties, put-in time, put-in position, and put-in rate of the additional substance.

The calculation device 35 may perform operations based on the method for creating a machine learning model shown in FIG. 5, the operations comprising: a first step S1 of creating a plurality of parameter sets including tank information, operating conditions of the tank 1, and substance information including additional substance information; a second step S2 of performing numerical fluid dynamics analyses based on the plurality of parameter sets to acquire a plurality of calculation results of fluid information, which are distributions of physical quantities of the fluid in the tank 1; and a third step S3 of creating a machine learning model by performing a machine learning operation that involves training the machine learning model using the plurality of parameter sets and the corresponding calculation results as teaching data. The so-created machine learning model can output fluid information (distributions of physical quantities related to the fluid) for the additional substance, including the pressure, flow velocity, flow velocity direction, and density of the fluid at each position in the tank 1.

The control device 30 inputs first fluid information about the state of the fluid at the first position P1 in the tank 1, the operating conditions, and the substance information to the machine learning model, to thereby acquire the fluid information as the output of the machine learning model. The substance information preferably includes information about a substance that has been in the tank 1 since the start of operation, as well as information on an additional substance. This means that the fluid information output by the machine learning model will be fluid information that takes into account the additional substance at each time point.

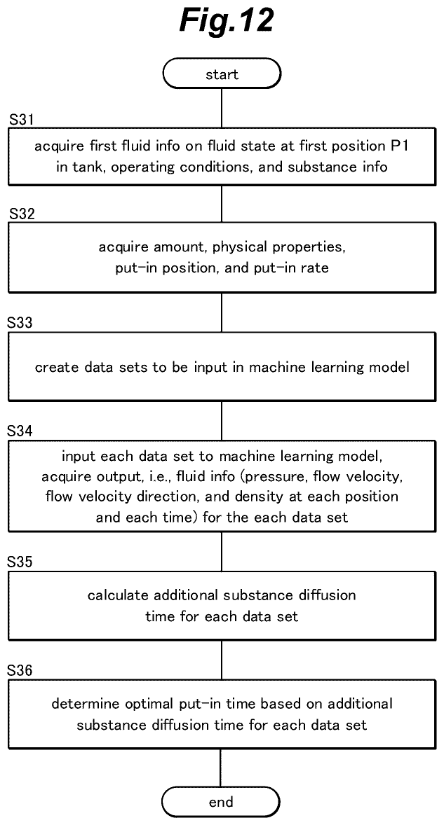

The control device 30 may perform an optimal put-in time calculation operation that outputs an optimal put-in time of the additional substance, the optimal put-in time from a reference time. For example, the control device 30 may calculate the optimal put-in time according to a flowchart of an operation procedure of an optimal put-in time calculation operation shown in FIG. 12.

The control device 30 starts the optimal put-in time calculation operation in response to an operator's input operation. First, the control device 30 acquires the first fluid information on the state of the fluid at the first position P1 in the tank 1, the operating conditions, and the substance information (S31). These pieces of information are preferably acquired in the same manner as the input to the machine learning model as described above.

Next, the control device 30 acquires the amount, physical properties, put-in position, and put-in rate of the additional substance based on the input operation of the operator (S32).

Of the amount, physical properties, put-in position, and put-in rate of the additional substance, those with predetermined values may be preset to eliminate the need for an operator's input.

Next, the control device 30 creates a plurality of data sets to be input to the machine learning model based on the information acquired in steps S31 and S32 (S33). Each data set includes first fluid information about the state of the fluid at the first position P1 in the tank 1, operating conditions, and substance information. The substance information includes the amount, physical properties, put-in position, put-in rate and put-in time of the additional substance. The data sets include the same values except that they differ from each other only in the put-in time of the additional substance. The put-in times of the additional substance in these sets are set at predetermined time intervals. The time interval may be, for example, 1 second to 1 hour.

Next, the control device 30 inputs each data set created in step S33 to the machine learning model, and acquires, as the output of the machine learning model, fluid information including the pressure, flow velocity, flow velocity direction, and density of the fluid at each position in the tank 1 at each future point of time corresponding to each data set (S34).

Next, the control device 30 calculates, for each data set, the time required for the diffusion of the additional substance in the tank 1 (hereinafter referred to as the diffusion time) based on the output of the machine learning model acquired in step S34 (S35). The diffusion time of an additional substance may be calculated as the time from the start of addition of the additional substance, until the difference in the concentration of the additional substance at each position in the tank 1 becomes less than a predetermined reference value. For each data set, the control device 30 can calculate the diffusion time of the additional substance based on the density of the additional substance at each position in the tank 1 at each future point of time acquired in step S34.

Next, based on the diffusion time of the additional substance for each data set acquired in Step S35, the control device 30 determines the put-in time of the additional substance for which the diffusion time is the shortest (S36). The put-in time of the additional substance that minimizes the diffusion time of the additional substance is then set as the optimal put-in time. Based on the diffusion time of the additional substance for each data set acquired in step S35, the control device 30 may determine the optimal put-in time using a search algorithm for solving optimization problems, such as the hill-climbing method.

The control device 30 may display the determined optimal put-in time on the display 31. In addition, when an additional substance is to be added to the fluid through the fluid inlet 6, the control device 30 may control the fluid inlet valve 11 to add the additional substance at the optimal put-in time.

### GLOSSARY

1 tank
3 stirring device
3A shaft
3B stirring blade
3C electric motor
4 baffle plate
6 fluid inlet
7 fluid outlet
8 vent port
11 fluid inlet valve
12 fluid outlet valve
13 vent port valve
15 sparger
16 gas supply device
20 sensor
25 temperature adjustment device
25A jacket
30 control device
31 display
32 operation screen
35 calculation device
P1 first position
P2 second position

1. A method for creating a machine learning model for estimating a state of a fluid in a tank, wherein the fluid contains a plurality of substances, the method comprising:
creating a plurality of parameter sets, each set comprising tank information including at least a shape and size of the tank, operating conditions of the tank, and substance information including at least an amount, and one or more physical properties of each of the plurality of substances, wherein the plurality of parameter sets are created by varying the parameters of the operating conditions and the substance information;
performing a numerical fluid dynamics analysis based on the plurality of parameter sets to provide a plurality of calculation results as fluid information, wherein the fluid information includes distributions of physical quantities related to the fluid and/or an amount of each of the plurality of substances; and
creating the machine learning model by a machine learning operation which involves training the machine learning model with teaching data including the plurality of parameter sets and the corresponding plurality of calculation results.

2. A method for creating a machine learning model for estimating a state of a fluid in a tank, wherein the fluid contains a plurality of substances, the method comprising:
creating a plurality of parameter sets, each set comprising tank information including at least a shape and size of the tank, operating conditions of the tank, and substance information including at least an amount, and one or more physical properties of each of the plurality of substances, wherein the plurality of parameter sets are created by varying the parameters of the tank information, the operating conditions, and the substance information;
performing a numerical fluid dynamics analysis based on the plurality of parameter sets to provide a plurality of calculation results as fluid information, wherein the fluid information includes distributions of a physical quantities related to the fluid and/or an amount of each of the plurality of substances; and
creating the machine learning model by a machine learning operation which involves training the machine learning model with teaching data including the plurality of parameter sets and the corresponding plurality of calculation results.

3. The method as claimed in claim 1, wherein the plurality of substances comprise cells or microorganisms, and
wherein the fluid information includes the distributions and/or the total number of the cells or microorganisms.

4. The method as claimed in claim 1, wherein the step of creating the machine learning model comprising:
extracting first fluid information related to the state of the fluid at a first position in the tank from the plurality of calculation results, and
creating the teaching data by using:
the tank information, the operating conditions of the tank, the one or more physical properties of each of the plurality of substances, and the extracted first fluid information as explanatory variables; and
the fluid information including the distributions of the physical quantities related to the fluid and/or the amount of each of the plurality of substances at each position in the tank as objective variables.

5. A method for estimating the state of the fluid in the tank using the machine learning model created by the method as claimed in claim 1, the method comprising:
inputting first fluid information related to the state of the fluid at a first position in the tank, the operating conditions, and the substance information to the machine learning model, thereby providing the fluid information as output data of the machine learning model.

6. A method for estimating the state of the fluid in the tank using the machine learning model created by the method as claimed in claim 1, the method comprising:
inputting first fluid information related to the state of the fluid at a first position in the tank, second fluid information related to the state of the fluid at a second position in the tank, the operating conditions, and the substance information to the machine learning model, thereby providing the fluid information as output data of the machine learning model.

7. A method for estimating the state of the fluid in the tank using the machine learning model created by the method as claimed in claim 2, the method comprising:
inputting first fluid information related to the state of the fluid at a first position in the tank, the tank information, the operating conditions, and the substance information to the machine learning model, thereby providing the fluid information as output data of the machine learning model.

8. The method as claimed in claim 5, wherein the plurality of substances comprise cells or microorganisms, and wherein the fluid information includes the distributions and/or the total number of the cells or microorganisms.

9. The method as claimed in claim 8, wherein the first fluid information is a number of the cells or microorganisms at the first position.

10. The method as claimed in claim 1, wherein the numerical fluid dynamics analysis is a first numerical fluid dynamics analysis, the method comprising:
performing a second numerical fluid dynamics analysis based on the plurality of parameter sets and a further parameter set related to an additional substance to be put into the tank after the tank starts operation;
calculating an additional substance diffusion time, which is a time required for the additional substance to diffuse to every position in the tank, based on results of the second numerical fluid dynamics analysis; and
creating the machine learning model by a machine learning operation which involves training the machine learning model with teaching data including the plurality of parameter sets and the further parameter set related to the additional substance, and the additional substance diffusion time.

11. A method for estimating the state of the fluid and the additional substance diffusion time required for the additional substance to diffuse in the tank using the machine learning model created by the method as claimed in claim 10, the method comprising:
inputting first fluid information related to the state of the fluid at a first position in the tank, the operating conditions, and the substance information to the machine learning model, thereby providing the fluid information as output data of the machine learning model; and
inputting first fluid information related to the state of the fluid at a first position in the tank, the operating conditions, the substance information, and information related to the additional substance to the machine learning model, thereby providing the substance information and the additional substance diffusion time as output data of the machine learning model.

12. The method as claimed in claim 5, wherein the substance information includes an amount, a physical quantity, a put-in position, and a put-in rate of an additional substance to be put into the tank at a predetermined put-in time.

13. The method as claimed in claim 12, further comprising:
inputting a plurality of sets of input data to the machine learning model, thereby providing a plurality of sets of the fluid information as output data of the machine learning model, wherein the plurality of sets of input data are created by varying the put-in time at which the additional substance is put into the tank;
calculating additional substance diffusion times, each being a time required for the additional substance to diffuse in the tank, for the plurality of sets of the fluid information; and
determining a put-in time which minimizes the additional substance diffusion time based on the additional substance diffusion times for the plurality of sets of the fluid information.
